(19) United States
(12) Patent Application Publication
(10) Pub. No.: US 2015/0235230 A1
(43) Pub. Date: Aug. 20, 2015

(54) PRIORITIZING CUSTOMER SERVICE

(71) Applicant: Comenity LLC, Columbus, OH (US)

(72) Inventors: Richard Barber AINSWORTH, III, Dublin, OH (US); David NACK, Bexley, OH (US); James WALZ, Blacklick, OH (US)

(73) Assignee: COMENITY LLC, Columbus, OH (US)

(21) Appl. No.: 14/616,448

(22) Filed: Feb. 6, 2015

Related U.S. Application Data
(60) Provisional application No. 61/940,749, filed on Feb. 17, 2014.

(51) Int. Cl. G06Q 30/00; G06Q 30/02

(52) U.S. Cl. CPC G06Q 30/016; G06Q 30/0271; G06Q 30/0267

(57) ABSTRACT

In a computer-implemented method for prioritizing customer service, personal information of a customer located at a store location is automatically accessed (wherein the accessing of personal information conforms to applicable privacy laws). The personal information is automatically analyzed. Customer service is prioritized for the customer based on the analyzed personal information while the customer is located at the store location.

### CROSS-REFERENCE TO RELATED APPLICATIONS

This application claims priority to U.S. Patent Application 61/940,749, filed on Feb. 17, 2014, entitled “VIRTUAL CREDIT CARD DISPLAY AND CONSUMER LOCATION DETERMINATION,” by Ainsworth et al., having Attorney Docket No. ADS-009.PRO, and assigned to the assignee of the present application, hereby incorporated by reference in its entirety.

### BACKGROUND

The number of customers located in a store oftentimes outnumbers the number of employees working at the store. Some customers may not receive proper customer service due to the inadequate number of employees currently working at the store. As a result, the customer service may be poor or may not occur to various customers.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 is a block diagram that illustrates an embodiment of a device and payment system.

FIG. 2 illustrates an embodiment of beacon system in a store.

FIG. 3 depicts a flow diagram for a method for prioritizing customer service, according to various embodiments.

FIG. 4 depicts a flow diagram for a method for prioritizing customer service, according to various embodiments.

### DESCRIPTION OF EMBODIMENTS

Reference will now be made in detail to various embodiments, examples of which are illustrated in the accompanying drawings. While various embodiments are discussed herein, it will be understood that they are not intended to be limiting. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding. However, embodiments may be practiced without one or more of these specific details. In other instances, well known methods, procedures, components, and circuits have not been described in detail as not to unnecessarily obscure aspects of the described embodiments.

### Embodiments of a Virtual Credit Card Displayed on a Mobile Device

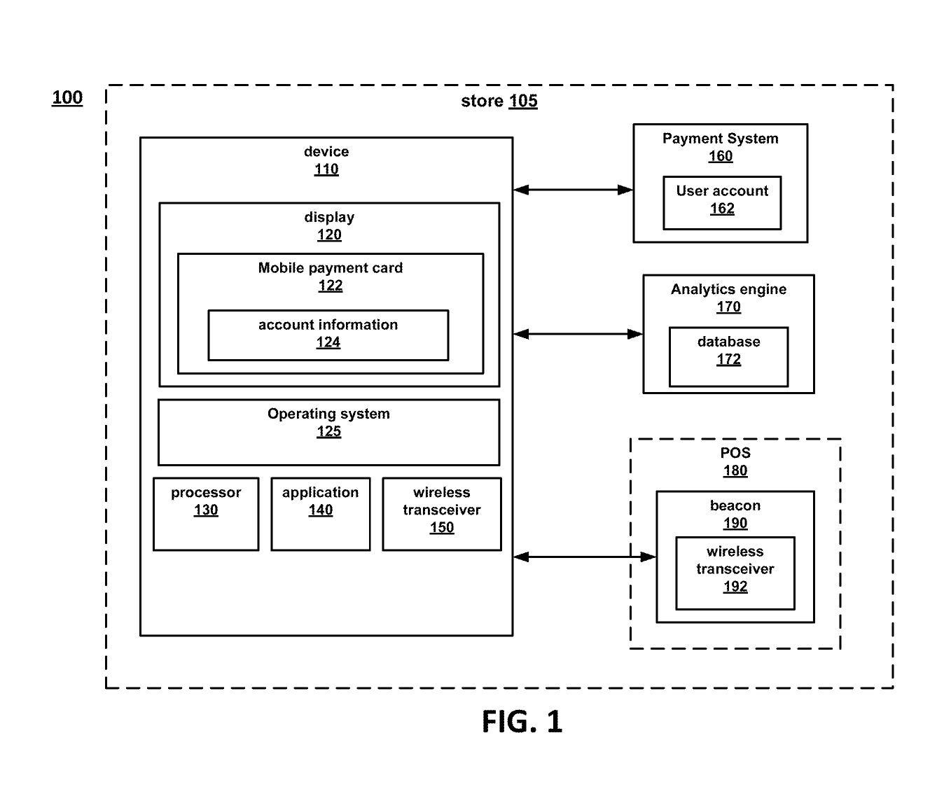

FIG. 1 depicts a block diagram that illustrates an embodiment of system 100. System 100 includes device 110 that is used by a person located at store 105. Device 110 is configured to be communicatively coupled with payment system 160, analytics engine 170 and/or beacon 190, which will be described in further detail below.

Device 110 includes display 120 that is able to display mobile payment card 122. Display 120, in one embodiment, is a touch screen, such that a user is able to interact with displayed features on the touch screen.

Device 110 may be a mobile device such as a smart phone, tablet, etc.

Device 110 includes operating system 125. In one embodiment, device 110 is an Apple iPhone™ (e.g., iPhone 4+ which includes, but not is not limited to, iPhone 4, 4S, 5, 5S and 5C). In such an embodiment, operating system 125 is an iOS 7+ operating system. The iOS 7 operating system is a mobile operating system developed and distributed by Apple Inc.

In another embodiment, device 110 is an Android mobile device because operating system 125 is an Android mobile operating system.

Operating system 125 includes an option (e.g., on/off) as to whether or not to allow automatic Bluetooth (or Bluetooth low energy (LE)) connection with device 110. In general, Bluetooth is a wireless technology standard for exchanging data over short distances (e.g., using short-wavelength radio waves in the ISM band from 2.4 to 2.485 GHz) from fixed and/or mobile devices.

In one embodiment, operating system 125 includes an ON default setting that automatically enables device 110 to have a Bluetooth connection with other devices. As a result, device 110 will automatically accept a Bluetooth invitation from other devices.

For example, beacon 190 transmits a Bluetooth invitation via wireless transceiver 192. If device 110 is in range of the transmitted Bluetooth invitation, then device 110 automatically sends a message back to beacon 190 via wireless transceiver 150 to accept the Bluetooth invitation. Accordingly, there is an automatic Bluetooth connection between device 110 and beacon 190.

Beacon 190 is any device that is configured to be communicatively coupled with device 110. For example, beacon 190 is a NFC enabled device.

In one embodiment, beacon 190 is an iBeacon™, which is an indoor positioning system from Apple Inc. For example, the iBeacon is a low-powered, low-cost transmitter that can notify nearby iOS 7 (and/or Android) devices of their presence.

Additionally, a user's mobile app (e.g., application 140) can be enabled to look for the transmission of beacon 190 (or any other beacons). When device 110 is within physical proximity to the beacon and detects it, the application can notify the customer of location-relevant content, promotions, and offers which will be described in further detail below.

Mobile payment card 122 can be any digital payment card that is able to be displayed on display 120 and utilized for purchases. In one embodiment, mobile payment card 122 is implemented via application 140. That is, application 140 (e.g., a mobile application) is downloaded onto device 110. When a user of device 110 selects application 140 to be utilized, processor 130 executes application 140 such that mobile payment card 122 is displayed on display 120. In another embodiment, mobile payment card 122 is supported by being downloaded over the Internet.

In one embodiment, mobile payment card 122 is a mobile credit card or a digital credit card. That is, the mobile payment card 122 is an electronic or digital version of a physical credit card. Mobile payment card 122 can also be referred to as mobile virtual credit card.

In general, a credit card is issued to users or consumers as a system of payment. It allows the cardholder to pay for goods and services based on the holder's promise to pay for them. The issuer of the card creates a revolving account and grants a line of credit to the consumer (or the user) from which the user can borrow money for payment to a merchant or as a cash advance to the user.

In one embodiment, mobile payment card 122 is a branded private label credit card. In general, a private label credit card is branded for a specific retailer, independent dealer or manufacturer. If the retailer does not manage the private label card, a third-party issues the cards and collects the payments from cardholders. Typically, terms and conditions for private label credit cards are made by contracts between the retailer and the third party. A retailer that provides the private label credit cards provides various incentives, offers, and advantages to its customers which results in a more satisfied customer and/or increased sales.

In various embodiments, mobile payment card 122 may be a mobile debit card, mobile cash card, mobile gift card, etc.

Mobile payment card 122 includes account information 124. Account information 124 can include, but is not limited to, name of user, billing address, account number, account balance/limit, card provider information, etc.

In one embodiment, account information is optically machine readable information. Optically machine readable information is any machine readable (or scanable) information that is able to be displayed on display 120 that enables access to or information related to user account 162 of payment system 160.

The optically machine readable information can be displayed in the form of a bar code (1D, 2D), quick response (QR) code, matrix code, etc.

In another embodiment, account information is the account number. For example, the consumer's account number is displayed.

In various embodiments, access to or information related to user account 162 may be accomplished by various means, such as, but not limited to, audio signals, Bluetooth low energy (LE), near field communication (NFC), etc.

Payment system 160 is any payment entity or mechanism that allows for purchases based on mobile payment card 122. For example, payment system 160 is an entity that issued mobile payment card 122 such as a bank, a corporation, etc.

In various embodiments, store 105 is a store or location with goods and/or services for sale. In one example, store 105 is a business/corporation such as Target™, REI™, Gap™, etc.

While at store 105, the customer is in possession of device 110. Moreover, the customer has a user account 162 associated with store 105. For example, a customer enters a Target™ store with the intention to peruse items for sale and potentially purchase items at store 105. The customer also has a Target™ private label credit card.

More specifically, application 140 is provided by store 105. For example, application 140 is a mobile application provided by Target™.

As such, application 140 enables mobile payment card 122 (e.g., a virtual credit card) to be displayed or surfaced on display 120 of device 110, which will be described in further detail below.

Beacon 190 is at or in proximity to point of sale (POS) 180. When the customer approaches the point of sale (POS), such as a register, with items for purchase, device 110 enters the range of the beacon 190. For example, beacon 190 transmits (e.g., broadcasts) a Bluetooth invitation having a range (e.g., 12-36 inches). Once in the beacons range, device 110 receives the Bluetooth (e.g., Bluetooth LE) invitation from beacon 190. In response, device 110 sends a signal back to beacon 190 via wireless transceiver 150. As a result, beacon 190 is able to recognize various information associated with device 110 (e.g., phone ID, etc.) and a connection is made between device 110 and beacon 190.

Additionally, in response to device 110 entering in the range of beacon 190 and a connection between device 110 and beacon 190, the consumer is prompted via display 120 if they would like mobile payment card 122 and/or account information 124 to be displayed (or surfaced). In one embodiment, beacon 190 transmits instructions to device 110 to initiate the prompt to the consumer (e.g., the user of device 110). A specific Beacon could be program/set up “anywhere” within the retailer's store to trigger via Bluetooth LTE the opening of the “mobile payment card” and thus replacing the existing security requirements of ID/Password resulting in a more timely and user friendly consumer interaction between the merchant and the consumer's mobile payment card. This also allows mobile payments to be transacted where/ when the consumer wishes to purchase within the retail store alleviating fixed POS.

If the consumer accepts, then mobile payment card 122 is displayed on display 120. Accordingly, mobile payment card 122 is readily displayed and available to the consumer for immediate purchase of goods/services at POS 180.

In one embodiment, account information 124 is displayed in the form of optically machine readable information (e.g., 2D barcode). As such, an optical scanner (e.g., bar code reader) at POS 180 is able to scan the account information for purchase of the goods/services.

In another embodiment, account information 124 is the account number. As such, the account number is read from display 120 and entered at POS 180 for purchase of the goods/services.

In one embodiment, authentication or security credentials are required prior to display of account information 124. The authentication/security credentials can be but are not limited to a PIN, finger/thumb print, voice command, etc. In one example, a user is prompted to enter a 4 digit PIN. In response to the correct PIN entered, account information 124 is displayed.

### Embodiments of Prioritizing Coverage

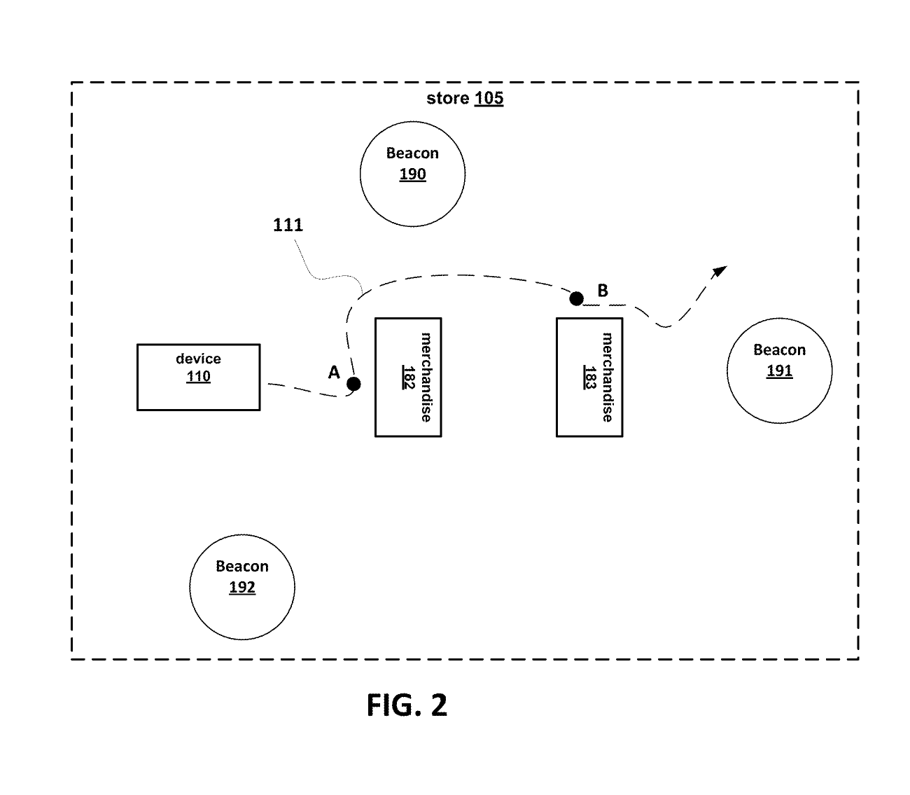

FIG. 2 depicts an embodiment of a block diagram of a consumer in possession of device 110 walking within store 105. Once the consumer enters store 105, device 110 is connected to one or more of beacons 190, 191 and 192. Although three beacons are depicted, any number of beacons may be employed within store 105 and communicating with device 110.

In response to device 110 being connected with a beacon, various user information associated with the user of device 110 may be obtained. The information may be stored in database 172. The information can be information provided by the user (e.g., name, birthday, address, age, number of children, etc.). The information may be provided via application 140 or during initiation of user account 162.

The user associated information may be any information derived from previous transactions or any other obtained information from various means. More specifically, analytics engine 170 may gather any data associated with the user and analyze such data and generate user associated information. For example, a user may typically purchase items towards the end of the month or on his wife's birthday. Accordingly, analytics engine generate information regarding the user that the user is inclined to purchase other items towards the end of the month or on near his wife's birthday.

It should be appreciated that the obtaining or accessing of user information conforms to applicable privacy laws (e.g., federal privacy laws, state privacy laws, etc.). In one embodiment, prior to accessing user information, the user affirmatively “opts-in” to the services described herein. For example, during an application for the use of the digital credit card, the user is prompted with a choice to affirmatively “opt-in” to various services, such as accessing at least some of the user's personal information. As a result, the user information is obtained with the user's prior permission.

Additionally, the user is provided with a “seamless” in-store experience (e.g., not being prompted to provide permission to accesses personal information while in the store) because the user affirmatively opted-in to the provided services prior to entering the store.

Additionally, analytics engine 170 may analyze information from thousands of other users and generate purchasing patterns and apply such patterns and analysis to other users. Such information is stored in database 172.

Analytics engine 170 may be a part of customer loyalty program. For example, analytics engine 180 facilitates in the execution a scalable plan to enhance marketing and customer engagement strategies. Also, engine may facilitate growing a business through data-driven loyalty and marketing solutions.

In various scenarios, there are more consumers at store 105 than store employees. It would be beneficial for the store employees to prioritize as to which consumer the employees should invest their time to serve and help the customer.

Prioritization may be accomplished based on the information of the user provided upon the connection between device 110 and one of the beacons. For example, one of the connected beacons is a trigger to obtaining the consumer information which forces a draw of information in database 172 or a calculation of information via analytics engine 170.

More specifically, for example, the information provided by analytics engine 170 indicates that the consumer in possession of device 110 has wife whose birthday is in two days. Therefore it can be presumed that the consumer has high likelihood to be influence-able to purchase an item at store 105.

The employees of store 105 (or sales associates) are provided the consumer's information. For example, the information may be displayed on mobile devices in possession of the store employees.

Based on the provided consumer information, the consumers in the store may be prioritized according to analytics provided by analytics engine 170. For example, the consumer whose wife's birthday in two days may have a higher priority ranking compared to a consumer who has been in the store many times but has rarely purchased any items.

Based on the prioritization of consumers provided to the store employees, the store employees may then make an informed decision on which consumers to invest their time in. For instance, the prioritization indicates that the consumer who may be looking for a gift for his wife is a priority and that the store employees should invest their time on that consumer to enhance conversion.

Moreover, analytics engine 170 may calculate various values for each customer that has a device that connects with a beacon. For example, analytics engine 170 may calculate a customer life value based on various data (e.g., transaction level detail, store visit frequency, consumer patterns in store derived from beacon based measurements, etc.).

Various discounts and incentives to drive offers to consumers may be derived from the values generated by the analytics engine. For example, a promotion may be provided to the consumer for all women's apparel because his wife's soon to be birthday. The promotion may be displayed on display 120.

### Embodiments of Location Determination

Referring to FIG. 2, beacons 190, 191 and 192 may be utilized to determine the location of the consumer via the connection between the device and the beacons. That is, the beacons may use various methods to determine the location of the consumer within store 105. For example, the system of beacons may use triangulation to determine the exact location of the device. In particular, the device transmits signals to the beacons. The beacons can determine the angles and distance with respect to the device and determine the location of the device within store 105.

The beacons are able to track the consumer while the consumer walks along path 111 throughout the store. For example, the consumer stops at location A to look at merchandise 182 for a duration of time, then moves along path 111 to location B to look at merchandise 183 for a duration of time, and so on.

While in store 105, the consumer is prompted via device 110 that offers are available. For example, an offers button is displayed on display 120. If the user accepts the offers then various offers are displayed to the user.

More specifically, offers are provided to the consumer that relate to the consumer's particular location. For example, while the consumer is at location A, looking at merchandise 182, a promotion or sale for merchandise 182 is provided to the consumer via device 110. Similarly, while consumer is at location A, looking at merchandise 183, a promotion or sale for merchandise 183 is provided to the consumer via device 110.

In another embodiment, consumer has a history of buying a particular item (e.g., brown sweaters) within merchandise 182. This information is provided via analytics engine 170. Accordingly, a promotion for brown sweaters is provided on display 120 while the consumer is at location 182 in the immediate proximity to brown sweaters.

In general, embodiments described herein include a system that provides offers to a consumer based on consumer location within the store and/or previous consumer actions (e.g., previous purchases, previous paths in store, etc.).

### Embodiments of Analytics Based on Consumer Location

As described above, the system of beacons can track the path of the consumer via device 110. Analytics engine 170 can access the consumer's locations and tracked path and correlate the information with various other consumer related information. As a result, additional analytical information can be generated that is based on the location of the consumer. This information can be utilized as a conversion tool.

In particular, the locations that the consumer stops is determined (e.g., location A and location B). Additionally, the consumer's path 111 is tracked by the beacons and the information is provided to analytics engine 170.

In some embodiments, the consumer's location is determined by the beacons within 12 inches of the consumer's actual location.

In one example, a user is prompted via display 120 that he/she will receive 500 loyalty points if the consumer agrees to being tracked within store 105. As such, in response to accepting the invitation, the consumer receives the additional loyalty points.

Various information may be correlated with the consumer's location to increase conversion. Such information can be, but is not limited to, amount purchased, number of trips to store, shopping on web, etc.

### Example Methods of Operation

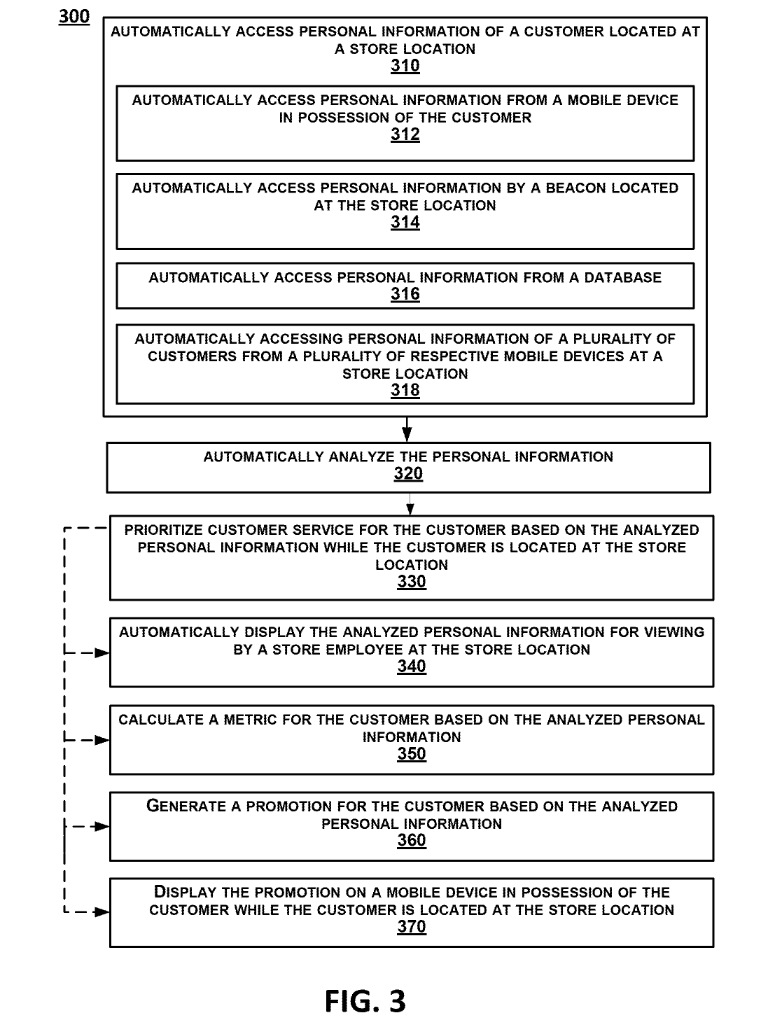

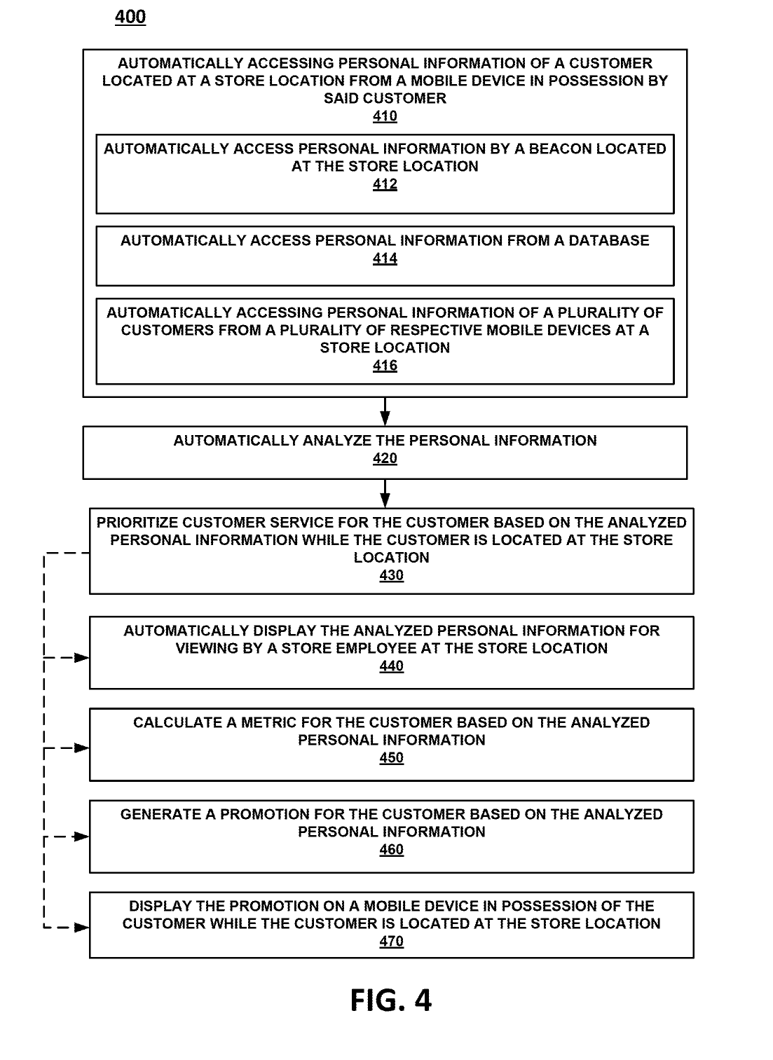

The following discussion sets forth in detail the operation of some example methods of operation of embodiments. With reference to FIGS. 3 and 4, flow diagrams 300 and 400 illustrate example procedures used by various embodiments. Flow diagrams 300 and 400 include some procedures that, in various embodiments, are carried out by a processor under the control of computer-readable and computer-executable instructions. In this fashion, procedures described herein and in conjunction with flow diagrams 300 and 400 are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments (e.g. system 100). The computer-readable and computer-executable instructions, which reside on tangible computer readable storage media, are used to control or operate in conjunction with, for example, one or some combination of processors of the computer environments. It is appreciated that the processor(s) may be physical or virtual or some combination (it should also be appreciated that a virtual processor is implemented on physical hardware). Although specific procedures are disclosed in flow diagrams 300 and 400, such procedures are examples. That is, embodiments are well suited to performing various other procedures or variations of the procedures recited in flow diagrams 300 and 400. Likewise, in some embodiments, the procedures in flow diagrams 300 and 400 may be performed in an order different than presented and/or not all of the procedures described in one or more of these flow diagrams may be performed. It is further appreciated that procedures described in flow diagrams 300 and 400 may be implemented in hardware, or a combination of hardware with firmware and/or software.

FIG. 3 depicts flow diagram 300 for a method for prioritizing customer service, according to various embodiments.

Referring now to FIG. 3, at 310, personal information of a customer located at a store location is automatically accessed. For example, beacons 190, 191 and/or 192 automatically access personal information from device 110 (with prior user opt-in where required). The information can be any personal information pertaining to the customer that may be useful for conversion. For example, the information is that the customer's wife has a birthday in two days. The information can be but is not limited to, store visit frequency, consumer patters in the store derived from beacon based measurements.

It is noted that any aspects pertaining to the automatic accessing of personal information, as described herein, conforms to applicable privacy laws. In one embodiment, the personal information is automatically accessed based on a user's prior affirmative opt-in that gives permission to access the user's personal information by various means.

At 312, personal information from a mobile device in possession of the customer is automatically accessed. For example, the personal information from a mobile device (e.g., device 110) is automatically accessed, wherein the mobile device is in the possession of the customer.

At 314, personal information by a beacon located at the store is automatically accessed. For example, beacons 190, 191 and/or 192 access the personal information of device 110.

At 316, personal information from a database is automatically accessed. For example, personal information is located in a database (e.g., database 172). Accordingly, when any one of the beacons accesses personal information from device 110, the accessing of the personal information triggers personal information already stored in database 172.

At 318, personal information of a plurality of customers from a plurality of respective mobile devices at a store location is automatically accessed. For example, a plurality of customers are located in store 105. As such, the mobile devices in possession of any one of the plurality of customers are accessed to obtain the personal information of the customers.

At 320, personal information is automatically analyzed. For example, analytics engine 170 analyzes the personal information obtained from device 110 and/or personal information obtained from database 172.

At 330, customer service for the customer is prioritized based on the analyzed personal information while the customer is located at the store location. For example, personal information of a first customer (in possession of device 110) indicates that the customer's wife has a birthday in a few days. As such, the customer service for the first customer is prioritized over other customers. In particular, an employee of the store is provided the personal information and focuses his/her attention on the first customer rather than the other customers in store 105.

At 340, the analyzed personal information is automatically displayed for viewing by a store employee at the store location. For example, an employee of the store views the personal information of the first customer that is displayed on a mobile device in possession of the employee. As such, the employee focuses his/her attention on the first customer rather than the other customers in store 105.

At 350, a metric for the customer is calculated based on the analyzed personal information. For example, a metric (e.g., customer life value) is calculated by analytics engine 170 based at least in part on personal information of a customer. The metric is then compared to metrics of other customers for prioritization of customer service.

At 360, a promotion for the customer is generated based on the analyzed personal information. For example, a promotion is generated for the customer to incentivize the customer to purchase a birthday gift for his wife whose birthday is in a couple of days.

At 370, the promotion is displayed on a mobile device in possession of the customer while the customer is located at the store location. For example, the promotion is displayed on display 120 of device 110 such that the customer is able to view the promotion from his personal mobile device.

It is noted that any of the procedures, stated above, regarding flow diagram 300 may be implemented in hardware, or a combination of hardware with firmware and/or software.

Referring now to FIG. 4, at 410, personal information of a customer located at a store location is automatically accessed from a mobile device in possession by the customer. For example, beacons 190, 191 and/or 192 automatically access personal information from a mobile device (e.g., device 110), wherein the mobile device is in the possession of the customer (with prior user opt-in where required). The information can be any personal information pertaining to the customer that may be useful for conversion. For example, the information is that the customer's wife has a birthday in two days. The information can be but is not limited to, store visit frequency, consumer patters in the store derived from beacon based measurements.

As described herein, any aspects pertaining to the automatic accessing of personal information conforms to applicable privacy laws. In one embodiment, the personal information is automatically accessed based on a user's prior affirmative opt-in that gives permission to access the user's personal information by various means.

At 412, personal information by a beacon located at the store is automatically accessed. For example, beacons 190, 191 and/or 192 access the personal information of device 110.

At 414, personal information from a database is automatically accessed. For example, personal information is located in a database (e.g., database 172). Accordingly, when any one of the beacons accesses personal information from device 110, the accessing of the personal information triggers personal information already stored in database 172.

At 416, personal information of a plurality of customers from a plurality of respective mobile devices at a store location is automatically accessed. For example, a plurality of customers are located in store 105. As such, the mobile devices in possession of any one of the plurality of customers are accessed to obtain the personal information of the customers.

At 420, personal information is automatically analyzed. For example, analytics engine 170 analyzes the personal information obtained from device 110 and/or personal information obtained from database 172.

At 430, customer service for the customer is prioritized based on the analyzed personal information while the customer is located at the store location. For example, personal information of a first customer (in possession of device 110) indicates that the customer's wife has a birthday in a few days. As such, the customer service for the first customer is prioritized over other customers. In particular, an employee of the store is provided the personal information and focuses his/her attention on the first customer rather than the other customers in store 105.

At 440, the analyzed personal information is automatically displayed for viewing by a store employee at the store location. For example, an employee of the store views the personal information of the first customer that is displayed on a mobile device in possession of the employee. As such, the employee focuses his/her attention on the first customer rather than the other customers in store 105.

At 450, a metric for the customer is calculated based on the analyzed personal information. For example, a metric (e.g., customer life value) is calculated by analytics engine 170 based at least in part on personal information of a customer. The metric is then compared to metrics of other customers for prioritization of customer service.

At 460, a promotion for the customer is generated based on the analyzed personal information. For example, a promotion is generated for the customer to incentivize the customer to purchase a birthday gift for his wife whose birthday is in a couple of days.

At 470, the promotion is displayed on a mobile device in possession of the customer while the customer is located at the store location. For example, the promotion is displayed on display 120 of device 110 such that the customer is able to view the promotion from his personal mobile device.

It is noted that any of the procedures, stated above, regarding flow diagram 400 may be implemented in hardware, or a combination of hardware with firmware and/or software.

Additionally, consumer analytics is generated based on at least in part on location of a consumer within a store. For example, a consumer is prompted to view offers based on the location of the consumer within the store. In another example, location based analytics are generated based at least in part on the locations of the consumer and/or paths of the consumer in the store.

1. A computer-implemented method for prioritizing customer service comprising:
automatically accessing personal information of a customer located at a store location;
automatically analyzing said personal information; and
prioritizing customer service for said customer based on said analyzed personal information while said customer is located at said store location.

2. The computer-implemented method of claim 1, further comprising:
automatically displaying said analyzed personal information for viewing by a store employee at said store location.

3. The computer-implemented method of claim 1, wherein said automatically accessing personal information further comprises:
automatically accessing personal information from a mobile device in possession of said customer.

4. The computer-implemented method of claim 1, wherein said automatically accessing personal information further comprises:
automatically accessing personal information by a beacon located at said store location.

5. The computer-implemented method of claim 1, wherein said automatically accessing personal information further comprises:
automatically accessing personal information from a database.

6. The computer-implemented method of claim 1, wherein said automatically accessing personal information further comprises:
automatically accessing personal information of a plurality of customers from a plurality of respective mobile devices at a store location.

7. The computer-implemented method of claim 1, further comprising:
calculating a metric for said customer based on said analyzed personal information.

8. The computer-implemented method of claim 1, further comprising:
generating a promotion for said customer based on said analyzed personal information.

9. The computer-implemented method of claim 8, further comprising:
displaying said promotion on a mobile device in possession of said customer while said customer is located at said store location.

10. A non-transitory computer-readable storage medium having instructions embodied therein that when executed cause a computer system to perform a method prioritizing customer service, the method comprising:
automatically accessing personal information of a customer located at a store location from a mobile device in possession by said customer;
automatically analyzing said personal information; and
prioritizing customer service for said customer based on said analyzed personal information while said customer is located at said store location.

11. The non-transitory computer-readable storage medium of claim 10, further comprising:
automatically displaying said analyzed personal information for viewing by a store employee at said store location.

12. The non-transitory computer-readable storage medium of claim 10, wherein said automatically accessing personal information further comprises:
automatically accessing personal information by a beacon located at said store location.

13. The non-transitory computer-readable storage medium of claim 10, wherein said automatically accessing personal information further comprises:
automatically accessing personal information from a database.

14. The non-transitory computer-readable storage medium of claim 10, wherein said automatically accessing personal information further comprises:
automatically accessing personal information of a plurality of customers from a plurality of respective mobile devices at a store location.

15. The non-transitory computer-readable storage medium of claim 10, further comprising:
calculating a metric for said customer based on said analyzed personal information.

16. The non-transitory computer-readable storage medium of claim 10, further comprising:
generating a promotion for said customer based on said analyzed personal information.

17. The non-transitory computer-readable storage medium of claim 16, further comprising:
displaying said promotion on said mobile device in possession of said customer while said customer is located at said store location.
